(19) United States
(12) Patent Application Publication
(10) Pub. No.: US 2007/0007076 A1
(43) Pub. Date: Jan. 11, 2007

(54) Hanging type escape apparatus

(76) Inventors: Hung-Hui Chen, Dajia Township (TW); Ta-Ming Chiu, Dajia Township (TW)

Correspondence Address: RABIN & BERDO, P.C., Suite 500, 1101 14th Street, Washington, DC, 20005, US

(21) Appl. No.: 11/242,928

(22) Filed: Oct. 5, 2005

(30) Foreign Application Priority Data
Jul. 5, 2005 (TW) 94211320

(51) Int. Cl. A62B 1/20

(52) U.S. Cl. 182/193

(57) ABSTRACT

A hanging type escape apparatus operating with an awl installed into an awl hole of a base of a belt, and the awl includes a sunken spiral groove at its surface for winding a rope, a fixed handle and a pressing handle disposed at the bottom of both sides of the base, so that the pressing handle is pivotally connected to the base, and both sides of the middle of the pressing handle include a link rod, and the other end of each link rod is pivtoally connected to a rotating plate, and the rotating plate is latched with a protusion at the bottom of the awl. Therefore, the escape apparatus can be carried to the escape location, and the rope at the top of the base can be tied and fixed according to the terrain of the site. After a user wears the escape apparatus properly, the awl and the base no longer attaches tightly to the rope, and the user can be descended to a ground, and thus achieving the effect of quickly escaping from the emergency site by the hanging method.

### BACKGROUND OF THE INVENTION

1. Field of the Invention

This invention relates to a hanging type escape apparatus which is portable to the escape location by a user when an emergency occurs, and the escape apparatus can be fixed and hanged downward according to the terrain of the emergency site and used for descending the user to the ground, so as to quickly evacauate the user from the emergency site.

2. Description of the Related Art

According to the present regulations of the fire control law, a general building must have an escape apparatus for emergency situations. However, there are various different kinds of escape apparatuses in the market, and most of them are fire escape sling installed at a fixed corner position of the building. The operating method of these escape apparatuses primarily ties a person with a rope first and then the rope is connected to the escape apparatus, so that the person can use the principle of pulleys together with the escape sling to slide down from one side of the sling to a safe place by the user's weight and escape from the site, and the other side of the sling rises to a hanging place and gets ready to carry another person, so that a continuous up and down transporation can be achived. However, most of the present fire-escape apparatuses are installed at the corner positions of a floor or a building, because the apparatus adopts a rope to transport people, and the rope no longer can achieve its expected result if it is moving and hitting the corners of the buidling or any other objects. Therefore, most of these escape apparatuses are designed and installed at a fixed position of the corners of a building and the users can be descended to a safe place. However, an emergency such as a fire does not necessarily occur at a fixed position, but it can occur anywhere. If the fire occurs at a place near the escape apparatus, but the route is blocked, then a person cannot escape from the site, or will be killed in the fire if the fire cannot be controlled immediately. Thereferoe, such escape apparatus cannot guarantee its use during a fire. After the user of the present escape apparatus is in a ready position of hanging down by the rope, the downward movement occurs immediately. However, the user is not pschologically ready or stays calm, the immediate downward movement may cause a second-time shock (after all most of the users have never used the escape apparauts before), particually in the situation of descending from a tall buiding to the ground without any fence protection, and most users are scared. The traditional escape apparatuses have not taken the mental state of users into consideration, and thus users are unable to adopt to the escape apparatus instantaneously.

### SUMMARY OF THE INVENTION

In view of the shortcomings of the prior art, the inventor of the present invention conducted extensive researches and experiments, and finally invented a hanging type escape apparatus in accordance with the present invention.

Therefore, it is a primary objective of this invention to provide a hanging type escape apparatus that operates with an awl installed into an awl hole of a base of a belt, and the awl includes a sunken spiral groove at its surface for winding a rope, and a fixed handle and a pressing handle disposed at the bottom of both sides of the base, so that the pressing handle is pivotally connected to the base, and both sides of the middle of the pressing handle include a link rod, and the other end of each link rod is pivtoally connected to a rotating plate, and the rotating plate is latched with a protusion at the bottom of the awl. Therefore, the escape apparatus can be carried or moved to the escape location when an emergency occurs, and the rope at the top of the base can be tied and fixed according to the terrain of the site, so that the user can be descended to the ground by the operation of the escape apparatus and thus achieving the effect of quickly escaping from the site by the hanging method.

Another objective of the present invention is to provide a hanging type escape apparatus operating with a pressing handle which is pressed accroding to the weight of the user and the environmental conditions of the time, so as to control the descending speed of the escape apparatus and achieve slow descending and braking effects.

### BRIEF DESCRIPTION OF THE DRAWINGS

FIG. 1 is an exploded view of the present invention;

FIG. 2 is a perspective view of the present invention;

FIG. 3 is a schematic view of the present invention when it is not operated;

FIG. 4 is a schematic view of the present invention when it is operated;

FIG. 5A is a schematic view of a belt being worn properly according to the present invention.

FIG. 5B is a schematic view of an application according a first preferred embodiment of the invention; and

FIG. 6 is a schematic view of an application according a second preferred embodiment of the invention.

### DETAILED DESCRIPTION OF THE PREFERRED EMBODIMENTS

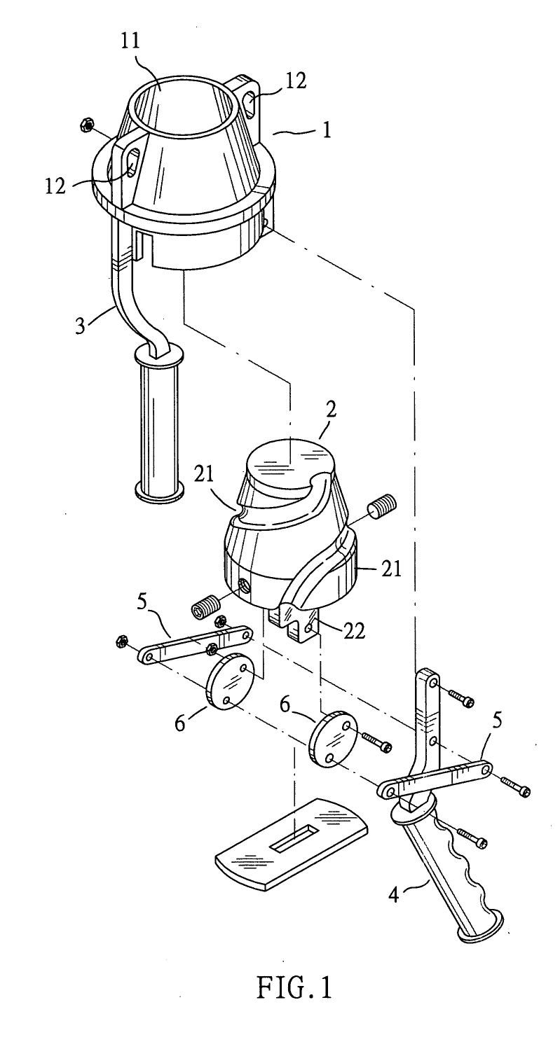

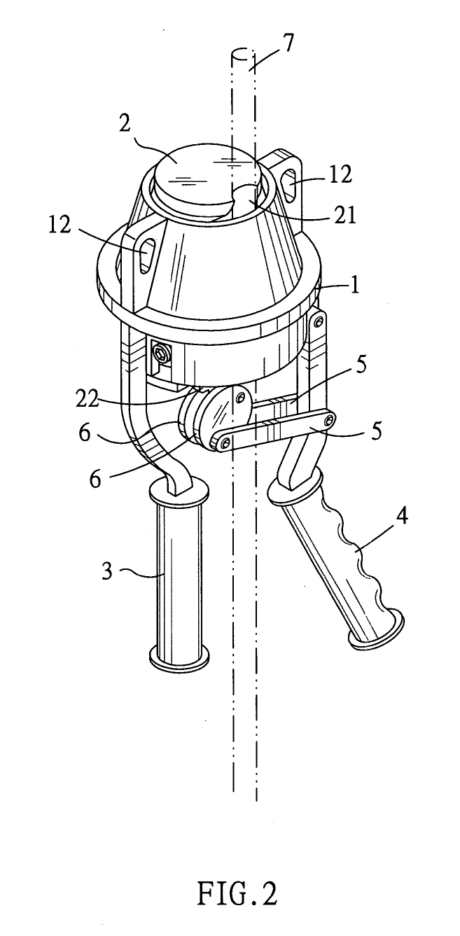

Referring to FIGS. 1 to 3 for the hanging type escape apparatus of the present invention, the escape apparatus comprises a base 1, an awl 2, a handle 3, a pressing handle 4, a link rod 5, and a rotating plate 6, and the base 1 includes a hollow awl hole 11 at the middle, a through hole 12 disposed at the top of both sides of the base 1 for connecting a belt A1 worn by a user A, and a fixed handle 3 and a pressing handle 4 disposed at the bottom After the pressing handle 4 is pivotally connected to the bottom of the base 1, the link rod 5 is pivotally and separately connected to both sides of the middle section of the pressing handle 4, and another end of each link rod is pivotally connected to the rotating plate 6, and the rotating plate 6 is latched to a protrusion 22 protruded at the lower end of the awl 2. The awl 2 is disposed in the hollow awl hole 11 at the middle of the base 1, and the surface of the awl 2 has a sunken spiral groove 21 for winding a rope 7, and the protrusion is protruded from the bottom.

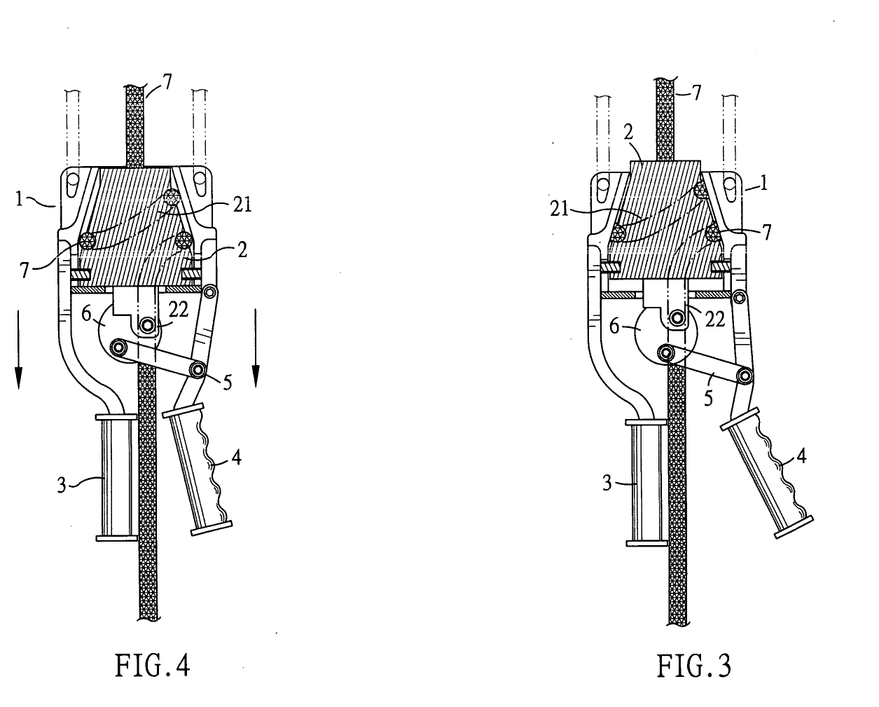

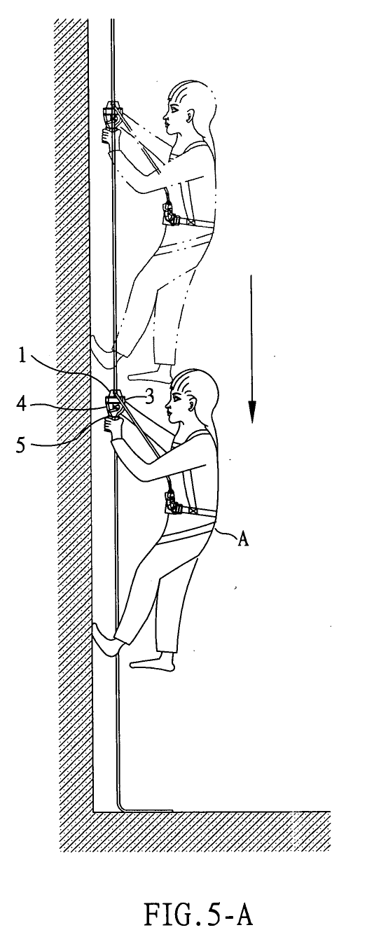

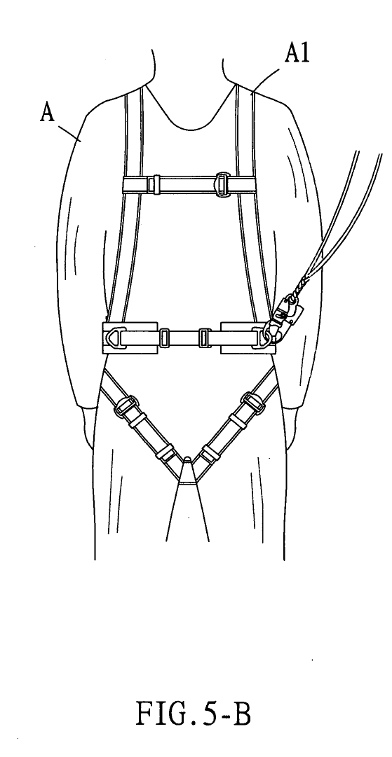

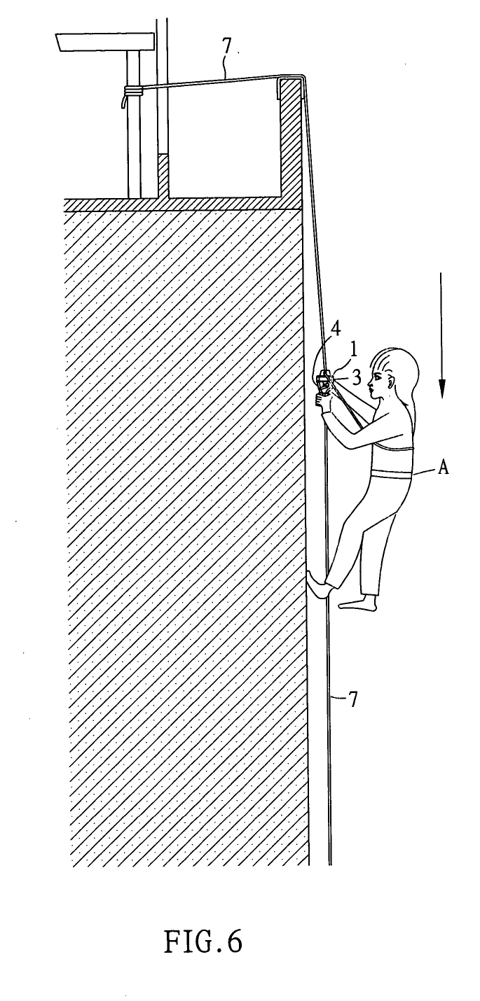

Since the components of the escape apparatus are very simple and the total weight of the escape apparatus is light, therefore the user A can carry the escape apparatus to the escape location and get ready for the escape when an emergency occurs. The rope 7 at the top of the base is tied and fixed according to the terrain of the site as shown in FIG. 6 and the user A1 wears the belt A as shown in FIG. 5A (or simply ties the user's body as shown in FIG. 6), and fixes the other end of the belt A1 to the through holes 12 on both sides of the base 1, and throws the lower section of the rope 7 below the base 1 out of the building, such that the rope 7 is in a dropping status. After the user A ties the belt A1 properly, the user A climbs out of the building, and uses the escape apparatus to descend by the rope 7. The rope 7 is wound around the sunken spiral groove 21 on the surface of the awl 2, and the surface of the awl 2 is in touch with the awl hole 11 at the middle of the base 1 (as shown in FIG. 3), therefore the user will not be descended. After the user A confirms the procedure and is psychologically ready for the descending, the users A can press the pressing handle 4 slowly. The link rod 5 is driven to pull the rotating plate 6 down, and then the awl 2 moves downward accordingly. Therefore, the surface of the awl 2 is no longer in contact with the awl hole 11 at the middle of the base 1 (as shown in FIG. 4), and the whole escape apparatus starts descending (as shown in FIG. 5 A FIG. 5 B and FIG. 6). After the user A gets used to the movements of the escape apparatus, the user A can press the pressing handle 4 harder to accelerate the descending speed. On the other hand, if the pressing handle 4 is no longer pressed, then the surface of the awl 2 is in contact with the awl hole 11 of the base 1 (as shwon in FIG. 3) to brake or slow down the descending. In the meantime, the escape appatus provides a pressing handle 4 for users to contol the descending speed of the escape apparatus according to the body weight of user A.

Therefore, the invention not only achieves the emergency escape effect by controlling the descending speed, but also provides a portable hanging type apparatus, so that the apparatus can be operated in any appropriate position of the emergency site. The invention can overcome the shortcomings of the prior art and achieve the effects of saving lives, and thus the invention complies with the requirements of patent applicaiton.

In summation of the above description, the present invention not only has innovative improvements over the prior art, but complies with the patent application requirements. While the invention has been described by means of specific embodiments, numerous modifications and variations could be made thereto by those skilled in the art without departing from the scope and spirit of the invention set forth in the claims.

What is claimed is:

1. A hanging type escape apparatus, comprising a base, an awl, a handle, a press handle, a link rod, and a rotating plate, and said base includes a hollow awl hole at its middle, a through hole on both sides of said base, and a fixed handle and a pressing handle disposed at the bottom, and said pressing handle is pivotally coupled with the bottom of said base, and then said link rod is pivotally and separately coupled to both sides of the middle section of said pressing handle, and the other end of said each link rod is pivotally coupled to said rotating plate, and said rotating plate is latched with a protrusion protruded from the lower end of said awl, and said awl is disposed into a hollow awl hole at the middle of the base, and the surface includes a sunken spiral groove for winding a rope, and the protrusion is protruded from the lower end, so that the total weight of the components is reduced and said escape apparatus can be carried easily for being hanged and fixed according to the terrain of an emergency site, and said pressing handle is pressed to descend said user to a ground along said rope, so as to achieve the effect of quickly descending said user.
The hanging type escape apparatus of claim 1, wherein said pressing handle is pressed according to the weight of said user and the environmental conditions of the time for controlling the descending speed of said escape apparauts and achieving slow descending and braking effects.
